(19) United States
(12) Patent Application Publication
(10) Pub. No.: US 2023/0118279 A1
(43) Pub. Date: Apr. 20, 2023

(54) RADIO RESOURCE CONFIGURATION FOR SELF-INTERFERENCE MEASUREMENT

(71) Applicant: QUALCOMM Incorporated, San Diego, CA (US)

(72) Inventors: Min HUANG, Beijing (CN); Yu ZHANG, San Diego, CA (US); Hui GUO, Beijing (CN)

(21) Appl. No.: 17/907,436

(22) PCT Filed: Apr. 14, 2021
(86) PCT No.: PCT/CN2021/087210

§ 371 Date: Sep. 27, 2022

(30) Foreign Application Priority Data
May 8, 2020 (WO) PCTCN2020089108

(51) Int. Cl. H04L 5/14; H04B 17/336; H04W 52/36; H04W 16/28

(52) U.S. Cl. CPC H04L 5/14; H04B 17/336; H04W 16/28; H04W 52/367

(57) ABSTRACT

Various aspects of the present disclosure generally relate to wireless communication. In some aspects, a node may receive configuration information that indicates a set of resources for self-interference measurement associated with a full-duplex communication mode; transmit a signal in accordance with the configuration information; determine a self-interference measurement based at least in part on the signal and the set of resources; and transmit information indicating the self-interference measurement. Numerous other aspects are provided.

### CROSS-REFERENCE TO RELATED APPLICATION

This Patent Application claims priority to PCT Patent Application No. PCT/CN2020/089108, filed on May 8, 2020, entitled “RADIO RESOURCE CONFIGURATION FOR SELF-INTERFERENCE MEASUREMENT,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for radio resource configuration for self-interference measurement.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a diagram illustrating examples of radio access networks, in accordance with various aspects of the disclosure.

FIG. 4 is a diagram illustrating an example of an IAB network architecture, in accordance with various aspects of the disclosure.

FIG. 5 is a diagram illustrating an example of communication links between IAB nodes and/or UEs of a network.

FIG. 6 is a diagram illustrating an example of self-interference, in accordance with various aspects of the present disclosure.

FIG. 7 is a diagram illustrating an example of configuring resources for self-interference measurement, in accordance with various aspects of the present disclosure.

FIG. 8 is a diagram illustrating an example process performed, for example, by a node, in accordance with various aspects of the present disclosure.

FIG. 9 is a diagram illustrating an example process performed, for example, by a base station, in accordance with various aspects of the present disclosure.

### SUMMARY

In some aspects, a method of wireless communication, performed by a node, may include receiving configuration information that indicates a set of resources for self-interference measurement associated with a full-duplex communication mode; transmitting a signal in accordance with the configuration information; determining a self-interference measurement based at least in part on the signal and the set of resources; and transmitting information indicating the self-interference measurement.

In some aspects, a method of wireless communication, performed by a base station, may include transmitting configuration information that indicates a set of resources for self-interference measurement by a node associated with a full-duplex communication mode; and receiving, from the node and in accordance with the configuration information, information indicating the self-interference measurement.

In some aspects, a node for wireless communication may include a memory and one or more processors operatively coupled to the memory. The memory and the one or more processors may be configured to receive configuration information that indicates a set of resources for self-interference measurement associated with a full-duplex communication mode; transmit a signal in accordance with the configuration information; determine a self-interference measurement based at least in part on the signal and the set of resources; and transmit information indicating the self-interference measurement.

In some aspects, a base station for wireless communication may include a memory and one or more processors operatively coupled to the memory. The memory and the one or more processors may be configured to transmit configuration information that indicates a set of resources for self-interference measurement by a node associated with a full-duplex communication mode; and receive, from the node and in accordance with the configuration information, information indicating the self-interference measurement.

In some aspects, a non-transitory computer-readable medium may store one or more instructions for wireless communication. The one or more instructions, when executed by one or more processors of a node, may cause the one or more processors to receive configuration information that indicates a set of resources for self-interference measurement associated with a full-duplex communication mode; transmit a signal in accordance with the configuration information; determine a self-interference measurement based at least in part on the signal and the set of resources; and transmit information indicating the self-interference measurement.

In some aspects, a non-transitory computer-readable medium may store one or more instructions for wireless communication. The one or more instructions, when executed by one or more processors of a base station, may cause the one or more processors to transmit configuration information that indicates a set of resources for self-interference measurement by a node associated with a full-duplex communication mode; and receive, from the node and in accordance with the configuration information, information indicating the self-interference measurement.

In some aspects, an apparatus for wireless communication may include means for receiving configuration information that indicates a set of resources for self-interference measurement associated with a full-duplex communication mode; means for transmitting a signal in accordance with the configuration information; means for determining a self-interference measurement based at least in part on the signal and the set of resources; and means for transmitting information indicating the self-interference measurement.

In some aspects, an apparatus for wireless communication may include means for transmitting configuration information that indicates a set of resources for self-interference measurement by a node associated with a full-duplex communication mode; and means for receiving, from the node and in accordance with the configuration information, information indicating the self-interference measurement.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, RF chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

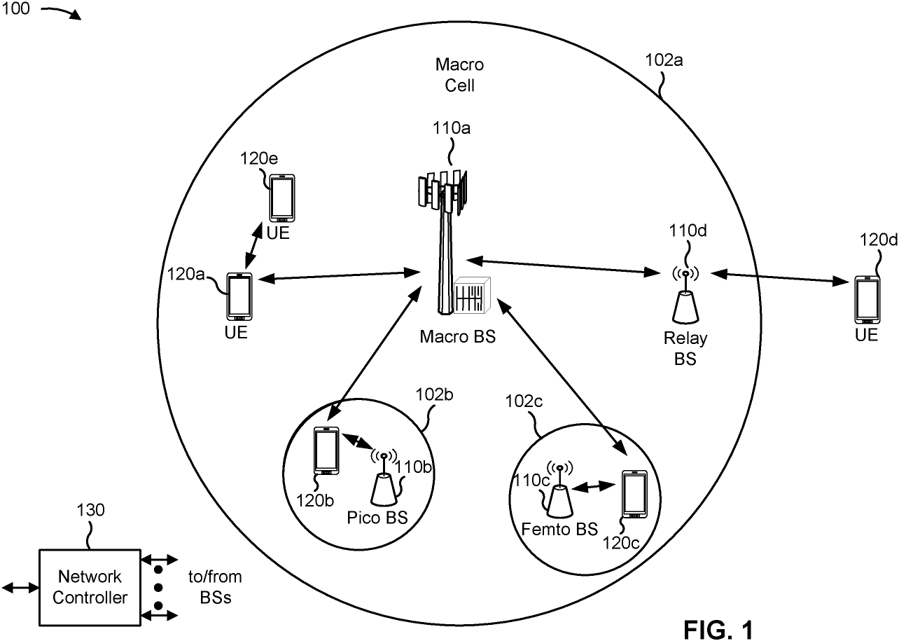

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5GNB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz - 300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

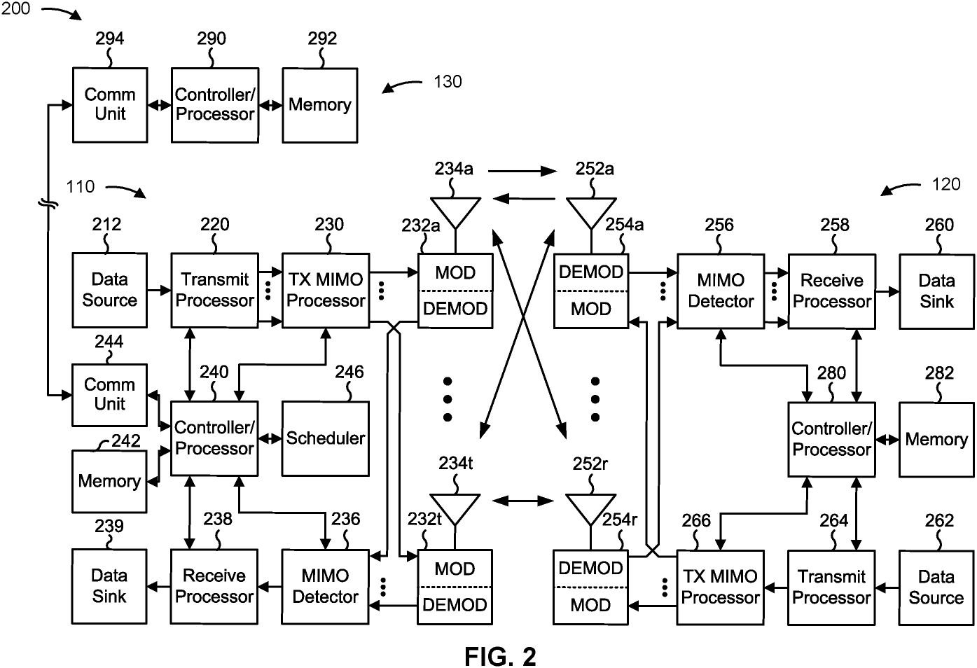

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T ≥ 1 and R ≥ 1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

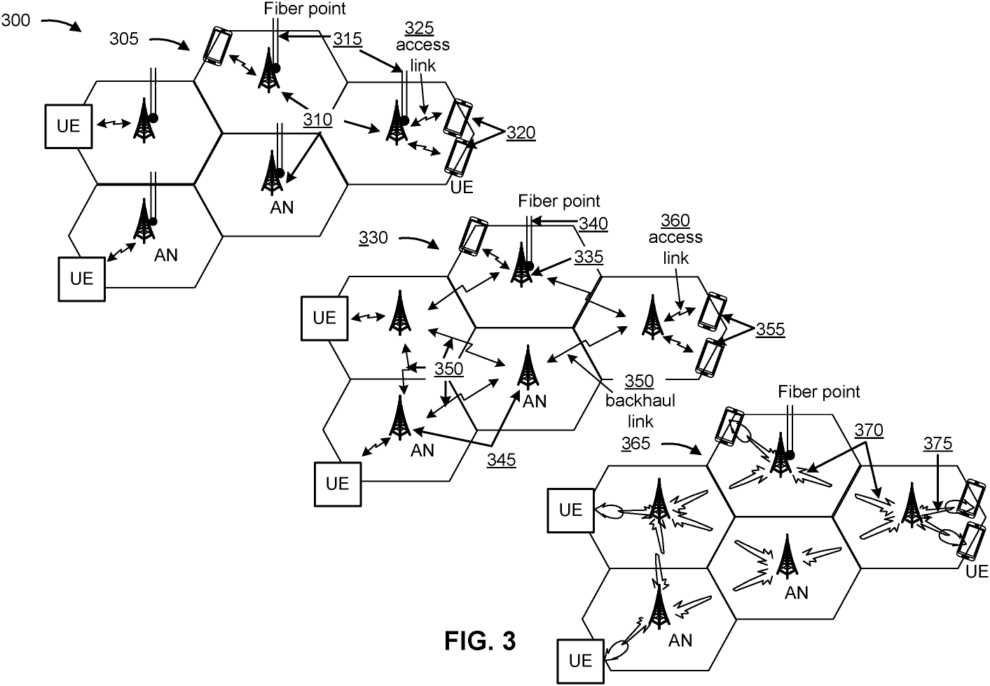

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 3-9.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 3-9.

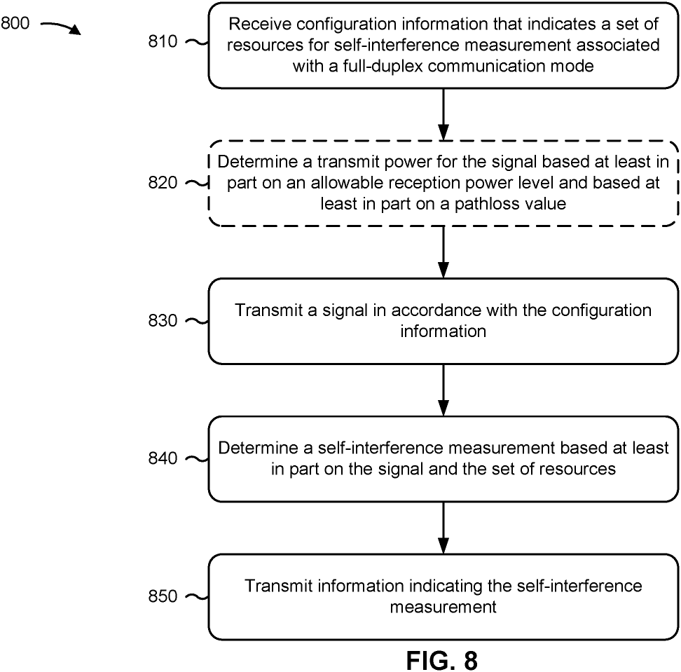

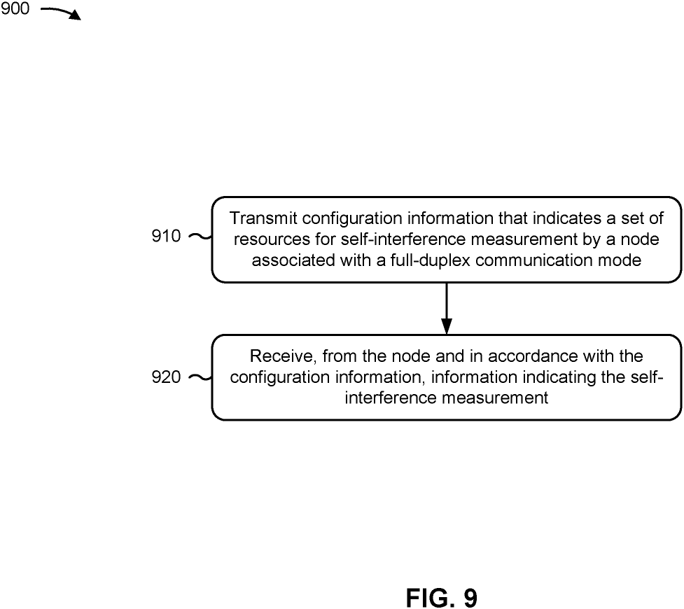

Controller/processor 240 of base station 110, controller/processor 280 of UE 120, and/or any other component(s) of FIG. 2 may perform one or more techniques associated with configuration of self-interference measurement, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some aspects, executing instructions may include running the instructions, converting the instructions, compiling the instructions, and/or interpreting the instructions, among other examples.

In some aspects, UE 120 may include means for receiving configuration information that indicates a set of resources for self-interference measurement associated with a full-duplex communication mode, means for transmitting a signal in accordance with the configuration information, means for determining a self-interference measurement based at least in part on the signal and the set of resources, means for transmitting information indicating the self-interference measurement, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting configuration information that indicates a set of resources for self-interference measurement by a node associated with a full-duplex communication mode, means for receiving, from the node and in accordance with the configuration information, information indicating the self-interference measurement and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

FIG. 3 is a diagram illustrating examples 300 of radio access networks, in accordance with various aspects of the disclosure.

As shown by reference number 305, a traditional (e.g., 3G, 4G, LTE, and/or the like) radio access network may include multiple base stations 310 (e.g., access nodes (AN)), where each base station 310 communicates with a core network via a wired backhaul link 315, such as a fiber connection. A base station 310 may communicate with a UE 320 via an access link 325, which may be a wireless link. In some aspects, a base station 310 shown in FIG. 3 may be a base station 110 shown in FIG. 1. In some aspects, a UE 320 shown in FIG. 3 may be a UE 120 shown in FIG. 1.

As shown by reference number 330, a radio access network may include a wireless backhaul network, sometimes referred to as an integrated access and backhaul (IAB) network. In an IAB network, at least one base station is an anchor base station 335 that communicates with a core network via a wired backhaul link 340, such as a fiber connection. An anchor base station 335 may also be referred to as an IAB donor (or IAB-donor). The IAB network may include one or more non-anchor base stations 345, sometimes referred to as relay base stations or IAB nodes (or IAB-nodes). The non-anchor base station 345 may communicate directly or indirectly with the anchor base station 335 via one or more backhaul links 350 (e.g., via one or more non-anchor base stations 345) to form a backhaul path to the core network for carrying backhaul traffic. Backhaul link 350 may be a wireless link. Anchor base station(s) 335 and/or non anchor base station(s) 345 may communicate with one or more UEs 355 via access links 360, which may be wireless links for carrying access traffic. In some aspects, an anchor base station 335 and/or a non-anchor base station 345 shown in FIG. 3 may be a base station 110 shown in FIG. 1. In some aspects, a UE 355 shown in FIG. 3 may be a UE 120 shown in FIG. 1.

As shown by reference number 365, in some aspects, a radio access network that includes an IAB network may utilize millimeter wave technology and/or directional communications (e.g., beamforming and/or the like) for communications between base stations and/or UEs (e.g., between two base stations, between two UEs, and/or between a base station and a UE). For example, wireless backhaul links 370 between base stations may use millimeter wave signals to carry information and/or may be directed toward a target base station using beamforming and/or the like. Similarly, the wireless access links 375 between a UE and a base station may use millimeter wave signals and/or may be directed toward a target wireless node (e.g., a UE and/or a base station). In this way, inter-link interference may be reduced.

The configuration of base stations and UEs in FIG. 3 is shown as an example, and other examples are contemplated. For example, one or more base stations illustrated in FIG. 3 may be replaced by one or more UEs that communicate via a UE-to-UE access network (e.g., a peer-to-peer network, a device-to-device network, and/or the like). In this case, a UE that is directly in communication with a base station (e.g., an anchor base station or a non-anchor base station) may be referred to as an anchor node.

As indicated above, FIG. 3 is provided as an example. Other examples may differ from what is described with regard to FIG. 3.

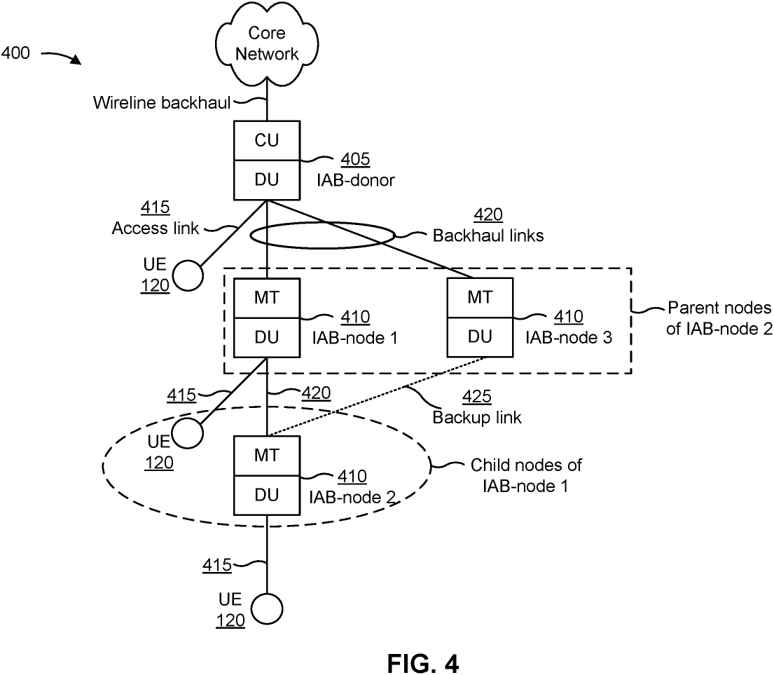

FIG. 4 is a diagram illustrating an example 400 of an IAB network architecture, in accordance with various aspects of the disclosure.

As shown in FIG. 4, an IAB network may include an IAB donor 405 (shown as IAB-donor) that connects to a core network via a wired connection (shown as a wireline backhaul). For example, an Ng interface of an IAB donor 405 may terminate at a core network. Additionally, or alternatively, an IAB donor 405 may connect to one or more devices of the core network that provide a core access and mobility management function (e.g., AMF). In some aspects, an IAB donor 405 may include a base station 110, such as an anchor base station, as described above in connection with 3. As shown, an IAB donor 405 may include a central unit (CU), which may perform access node controller (ANC) functions, AMF functions, and/or the like. In some aspects, the CU may be referred to as a central controlling node (CCN). The CU may configure a distributed unit (DU) of the IAB donor 405 and/or may configure one or more IAB nodes 410 (e.g., an MT and/or a DU of an IAB node 410) that connect to the core network via the IAB donor 405. Thus, a CU of an IAB donor 405 may control and/or configure the entire IAB network that connects to the core network via the IAB donor 405, such as by using control messages and/or configuration messages (e.g., a radio resource control (RRC) configuration message, an F1 application protocol (F1AP) message, and/or the like).

As further shown in FIG. 4, the IAB network may include IAB nodes 410 (shown as IAB-node 1, IAB-node 2, and IAB-node 3) that connect to the core network via the IAB donor 405. As shown, an IAB node 410 may include mobile termination (MT) functions (also sometimes referred to as UE functions (UEF)) and may include DU functions (also sometimes referred to as access node functions (ANF)). The MT functions of an IAB node 410 (e.g., a child node) may be controlled and/or scheduled by another IAB node 410 (e.g., a parent node of the child node) and/or by an IAB donor 405. The DU functions of an IAB node 410 (e.g., a parent node) may control and/or schedule other IAB nodes 410 (e.g., child nodes of the parent node) and/or UEs 120. Thus, a DU may be referred to as a scheduling node or a scheduling component, and an MT may be referred to as a scheduled node or a scheduled component. In some aspects, an IAB donor 405 may include DU functions and not MT functions. That is, an IAB donor 405 may configure, control, and/or schedule communications of IAB nodes 410 and/or UEs 120. A UE 120 may include only MT functions, and not DU functions. That is, communications of a UE 120 may be controlled and/or scheduled by an IAB donor 405 and/or an IAB node 410 (e.g., a parent node of the UE 120).

When a first node controls and/or schedules communications for a second node (e.g., when the first node provides DU functions for the second node’s MT functions), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an IAB donor 405 or an IAB node 410, and a child node may be an IAB node 410 or a UE 120. Communications of an MT function of a child node may be controlled and/or scheduled by a parent node of the child node.

As further shown in FIG. 4, a link between a UE 120 (e.g., which only has MT functions, and not DU functions) and an IAB donor 405, or between a UE 120 and an IAB node 410, may be referred to as an access link 415. Access link 415 may be a wireless access link that provides a UE 120 with radio access to a core network via an IAB donor 405, and optionally via one or more IAB nodes 410. Thus, the network illustrated in FIG. 4 may be referred to as a multi-hop network or a wireless multi-hop network.

As further shown in FIG. 4, a link between an IAB donor 405 and an IAB node 410 or between two IAB nodes 410 may be referred to as a backhaul link 420. Backhaul link 420 may be a wireless backhaul link that provides an IAB node 410 with radio access to a core network via an IAB donor 405, and optionally via one or more other IAB nodes 410. In an IAB network, network resources for wireless communications (e.g., time resources, frequency resources, spatial resources, and/or the like) may be shared between access links 415 and backhaul links 420. In some aspects, a backhaul link 420 may be a primary backhaul link or a secondary backhaul link (e.g., a backup backhaul link). In some aspects, a secondary backhaul link may be used if a primary backhaul link fails, becomes congested, becomes overloaded, and/or the like. For example, a backup link 425 between IAB-node 2 and IAB-node 3 may be used for backhaul communications if a primary backhaul link between IAB-node 2 and IAB-node 1 fails. As used herein, an IAB donor 405 or an IAB node 410 may be referred to as a node or a wireless node.

In some cases, an IAB node 410 may experience self-interference due to full-duplex operation. In this case, the IAB node 410 may perform self-interference measurement to detect and/or mitigate the self-interference. However, if other UEs or nodes near the IAB node 410 are performing data reception at a same time-frequency resource as is used for the self-interference measurement, then a signal used for self-interference measurement may interfere with the other UEs or nodes. Some techniques and apparatuses described herein provide scheduling and/or configuration of rules for transmission of a signal used for self-interference management, so as to reduce, eliminate, or avoid interference with nearby nodes and/or UEs.

As indicated above, FIG. 4 is provided as an example. Other examples may differ from what is described with regard to FIG. 4.

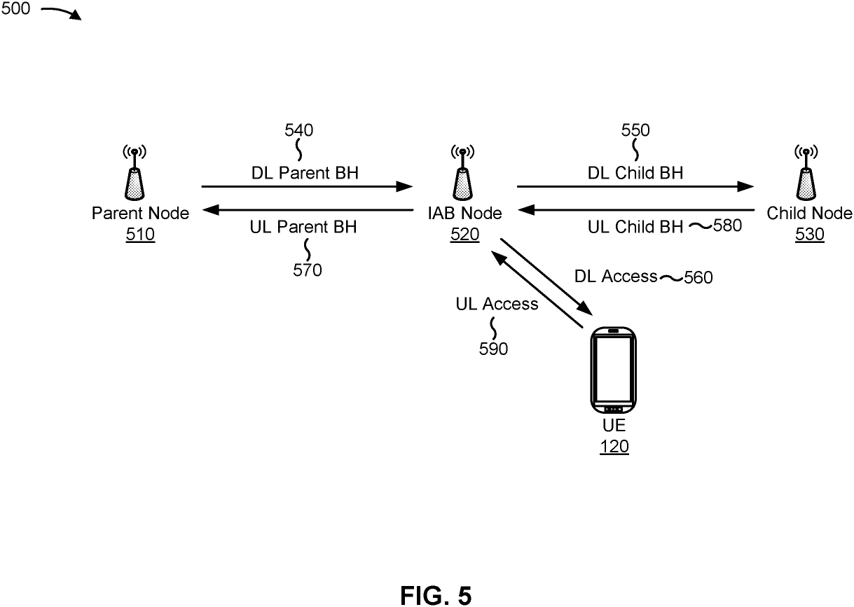

FIG. 5 is a diagram illustrating an example 500 of communication links between IAB nodes and/or UEs of a network. As shown, example 500 includes a parent node 510, an IAB node 520, a child node 530, and a UE 120. Parent node 510, IAB node 520, and child node 530 may each be an IAB node (e.g., a BS 110, a relay BS 110, a wireless node, and/or the like). In some aspects, parent node 510 may be an IAB donor. Parent node 510 is a parent node of IAB node 520, and child node 530 is a child node of IAB node 520. Child node 530 may be referred to as a grandchild node of parent node 510, and parent node 510 may be referred to as a grandparent node of child node 530. The network may be associated with a CU (not shown in FIG. 5).

The nodes 510, 520, 530, and the UE 120, are associated with communication links between each other. Downlink (DL) communication links are shown by reference numbers 540, 550, and 560. DL parent backhaul (BH) link 540 provides a DL backhaul (i.e., backhaul link) from parent node 510 to IAB node 520. DL child BH link 550 provides a DL backhaul from IAB node 520 to child node 530. DL access link 560 provides a DL access link from IAB node 520 to UE 120. Uplink (UL) communication links are shown by reference numbers 570, 580, and 590. UL parent backhaul (BH) link 570 provides a UL backhaul to parent node 510 from IAB node 520. UL child BH link 580 provides a UL backhaul to IAB node 520 from child node 530. UL access link 590 provides a UL access link to IAB node 520 from UE 120.

In some cases, IAB node 520 may experience self-interference. For example, if IAB node 520 is associated with a full-duplex communication mode, the transmitted signal in any transmission link may cause self-interference to the received signal in any reception link. As one example, the transmitted signal in the UL Parent BH link 570 may cause self-interference to a concurrently received signal in the UL child BH link 580 or the UL access link 590. When this interference strength is large enough (e.g., larger than a thermal noise power level), the interference may impair the reception performance of the corresponding channel or signal. Some techniques and apparatuses described herein provide configuration of self-interference measurement for one or more nodes, such as IAB node 520 or UE 120.

As indicated above, FIG. 5 is provided as an example. Other examples may differ from what is described with regard to FIG. 5.

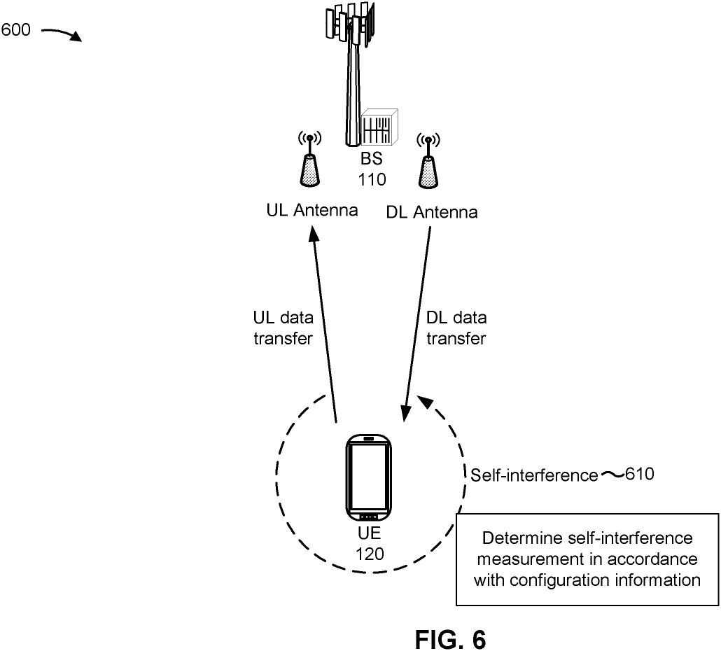

FIG. 6 is a diagram illustrating an example 600 of self-interference, in accordance with various aspects of the present disclosure. As shown, example 600 includes a BS 110 and a UE 120. BS 110 is associated with a UL antenna set and a DL antenna set. In some aspects, the UL antenna set may include an antenna group, an antenna panel, an antenna array, an antenna sub-array, a TRP, and/or the like. In some aspects, the DL antenna set may include an antenna group, an antenna panel, an antenna array, an antenna sub-array, a TRP, and/or the like. In some aspects, the UL antenna set can be located remotely from the DL antenna set to reduce inter-talk interference between the UL antenna set and the DL antenna set. In some aspects, the UL antenna set may be located close to the DL antenna set, or may be integrated with the DL antenna set as a single antenna set, if the inter-antenna interference can be mitigated sufficiently.

The UE 120 may be capable of transmitting a signal (shown as UL data transfer) and receiving a signal (shown as DL data transfer) at the same time-frequency radio resource. A simultaneous transmission and reception of signals on the same time-frequency resource is referred to herein as full-duplex communication. Full-duplex communication may be most efficient when the self-interference caused by the transmitted signal to the received signal, shown by reference number 610, can be mitigated so that both the DL data transfer and UL data transfer are effective.

A full-duplex UE may not always operate in a full-duplex communication mode. For example, the UE 120 may selectively operate in a full-duplex mode or a non-full-duplex mode based at least in part on factors such as whether the full-duplex mode can achieve higher data rate than the non-full-duplex mode. Due to differences in product design and hardware/software implementation, the capabilities for mitigating self-interference by some full-duplex UEs may differ. A UE’s capability for mitigating self-interference may be fixed, or may be variant with the UE’s transmission power, transmission bandwidth, transmission beamforming (precoding) weight, or other factors.

In some aspects, a UE 120 may be configured with one or more channel state information interference measurement (CSI-IM) resource set configurations, as indicated by a higher layer parameter CSI-IM-ResourceSet. Each CSI-IM resource set may include K≥1 CSI-IM resources. For a CSI-IM resource, the parameters of “CSI-IM resource pattern,” “periodicity and offset,” and “frequency band” may be configured. A CSI-IM resource pattern may indicate the frequency-domain and time-domain locations of resource elements in one occasion of a CSI-IM resource. In many cases, a serving gNB (e.g., BS 110) may not transmit a data signal or a reference signal at CSI-IM resources, so that the UE 120 can measure the inter-cell interference at these resources and transmit a CSI report to the serving gNB. The gNB can configure periodic, semi-persistent, or aperiodic CSI-IM resources for the UE 120, corresponding to periodic, semi-persistent, or aperiodic CSI reports, respectively.

As indicated above, FIG. 6 is provided as an example. Other examples may differ from what is described with regard to FIG. 6.

Next generation wireless networks (e.g., 5G/NR and/or the like) are expected to provide ultra-high data rates and support a wide scope of application scenarios. Wireless full-duplex (sometimes abbreviated FD) communications are theoretically capable of doubling the link capacity. In a wireless full-duplex communication mode, a radio network node may transmit and receive contemporaneously on the same frequency band and at the same time slot. This contrasts with conventional half duplex operation, where transmission and reception either differ in time or in frequency.

A full-duplex network node, such as a base station in a cellular network or an IAB node in an IAB network, can communicate contemporaneously in the uplink (UL) and the downlink (DL) with two half-duplex terminals using the same radio resources. Another typical wireless full-duplex application scenario is that one relay node can communicate contemporaneously with an anchor node and a mobile terminal in a one-hop scenario, or with two relay nodes in a multi-hop scenario. It is expected that by doubling each single-link capacity, full-duplexing can significantly increase the system throughput in diverse applications in wireless communication networks, and also reduce the transfer latency for time critical services.

In some cases, a UE, referred to as an FD-capable UE, may have the capability of contemporaneous transmission and reception using the same time-frequency radio resource. This may be referred to as working in self-FD mode or operating in an FD communication mode. Thus, the single-UE aggregated DL and UL throughput can be greatly increased, which may be particularly beneficial when both DL and UL traffic are high for a single user.

Full-duplex communication may involve self-interference cancellation for in-band full-duplex transmission. Some full-duplex radio designs can suppress some degree of such self-interference (e.g., from the uplink to the downlink or from the downlink to the uplink) by combining the technologies of beamforming, analog cancellation, digital cancellation, and antenna cancellation.

To measure self-interference, a full-duplex UE or node may transmit a signal while measuring the downlink channel quality by receiving a reference signal (e.g., a channel state information reference signal (CSI-RS)). A full-duplex UE may transmit a signal to emulate the self-interference from an uplink signal (e.g., a physical uplink shared channel (PUSCH), a sounding reference signal (SRS), a physical random access channel (PRACH), and/or the like) to a downlink signal. However, if other UEs or nodes near this UE or node are performing data reception at the same time-frequency resource, this signal may cause interference to them. For example, if a UE at the same cell is receiving a downlink signal (such as a physical downlink shared channel (PDSCH) or a CSI-RS), or if a BS at a neighbor cell is receiving an uplink signal (such as a PUSCH or an SRS), these nodes may experience interference due to the signal transmitted by the full-duplex UE or node.

Some techniques and apparatuses described herein provide configuration of a set of radio resources (e.g., time-frequency resources) for self-interference measurement by a full-duplex UE or node. “Self-interference measurement” refers to determining a measurement that indicates interference caused by a transmit beam of a UE with regard to a receive beam of the UE. “Self-interference measurement” can also refer to a measurement value determined by performing self-interference measurement. Self-interference measurement can be performed by transmitting a signal on a first (transmit) beam and determining a level of interference associated with transmitting the signal using a second (receive) beam. Self-interference measurement can be performed with regard to a single transmit beam and a single receive beam, multiple transmit beams and a single receive beam, or multiple transmit beams and multiple receive beams. For example, the configuration of the radio resources may involve configuration of a maximum transmit power parameter, a set of allowable (or disallowed) beamforming directions, a transmission sequence, and/or the like. The full-duplex UE or node may measure self-interference strength based at least in part on these configurations. For example, the UE may transmit a signal at the configured time-frequency resources with the configured power and/or beamforming direction, and may measure the self-interference accordingly. The UE may report, to a base station, a self-interference strength value or a CSI value that is calculated based at least in part on the self-interference strength. Thus, the base station can configure power levels, beamforming directions, resources, and/or signal sequences that mitigate or prevent interference from a full-duplex UE or node to another UE or node as part of the self-interference measurement procedure. Mitigating or preventing such interference improves efficiency of communication for the other UEs or nodes, thereby improving network performance and conserving computing and communication resources.

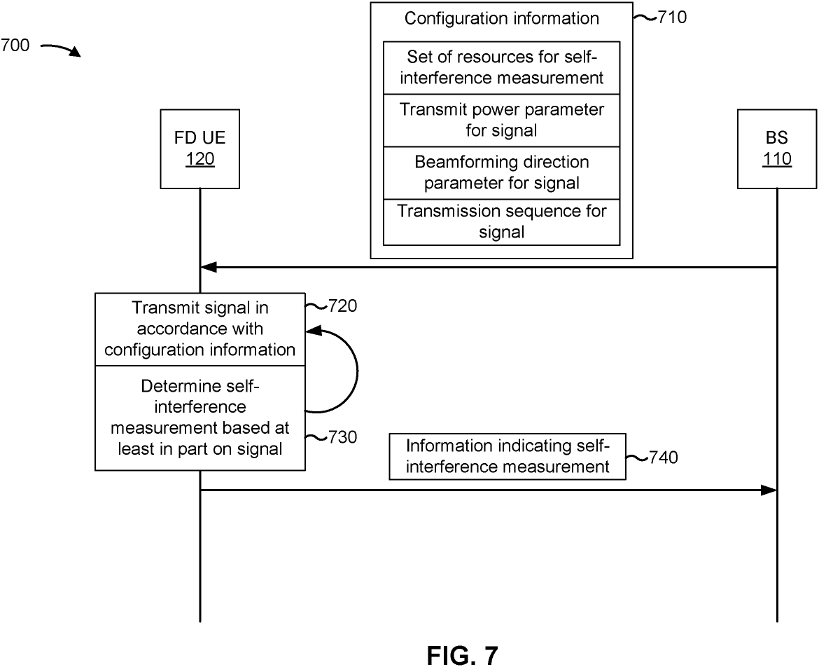

FIG. 7 is a diagram illustrating an example 700 of configuring resources for self-interference measurement, in accordance with various aspects of the present disclosure. As shown, example 700 includes a UE 120 and a BS 110. The UE 120 may be a full-duplex UE, meaning that the UE 120 is operating in a full-duplex communication mode in example 700. The operations described in example 700 can also be applied for an IAB node. In such a case, UE 120 in example 700 may represent an IAB node, and BS 110 may represent an IAB donor (e.g., a CU/CCN of the IAB donor), a parent node of the IAB node, and/or the like.

As shown by reference number 710, the BS 110 may transmit configuration information to the UE 120. The configuration information may be provided using downlink control information (DCI) signaling, medium access control (MAC) signaling (e.g., a MAC control element), radio resource control (RRC) signaling, and/or the like. In some aspects, the configuration information may be provided in a CSI report configuration message. As shown, the configuration information may include one or more of information indicating a set of resources for self-interference measurement associated with a full-duplex communication mode, information indicating a transmit power parameter for a signal, information indicating a beamforming direction parameter for the signal, or information indicating a transmission sequence for the signal. The signal may include any signal used for self-interference measurement, as described in more detail elsewhere herein.

In some aspects, the configuration information may indicate a transmission sequence for the signal. For example, the UE 120 may transmit any arbitrary sequence (such as might be used for a CSI-IM resource) if the configuration information does not indicate a transmission sequence. If the configuration information indicates a transmission sequence, then the UE 120 may use the indicated transmission sequence for the signal. For example, the transmission sequence may comprise an NZP-CSI-RS for interference measurement, and/or the like.

In some aspects, the configuration information may indicate a set of resources for the self-interference measurement. For example, if the self-interference measurement is performed when the UE 120 is receiving an NZP-CSI-RS, the time-frequency location of the self-interference measurement may coincide with the resource elements (REs) of an NZP-CSI-RS resource associated with the NZP-CSI-RS. In this case, in some aspects, the BS 110 may explicitly configure the RE locations (e.g., symbol indexes, subcarrier indexes, and/or the like) for the self-interference measurement to match the NZP-CSI-RS resource. If the NZP-CSI-RS resource is a periodic resource, then the BS 110 may also configure a period and/or an offset that matches the periodic resource. In some aspects, the BS 110 may implicitly configure a resource location of the self-interference measurement that matches the associated NZP-CSI-RS resource. For example, the BS 110 may provide an indication that the NZP-CSI-RS resource is to be used as the self-interference management resources. Explicit signaling may provide increased flexibility, whereas implicit signaling may reduce overhead.

In some aspects, the configuration information may indicate a transmit power parameter for a signal. For example, to reduce interference to another UE or node (e.g., a base station or an IAB node) that receives the signal for self-interference measurement at the same time-frequency resource as the self-interference measurement, the BS 110 may indicate a transmit power parameter to the UE 120. In some aspects, the transmit power parameter may indicate a maximum transmit power for the signal. In this case, the UE 120 may not be permitted to transmit a signal with a transmission power higher than a threshold defined by the maximum transmit power.

In some aspects, the transmit power parameter may indicate an allowable reception power level. The allowable reception power level may indicate a threshold of an expected reception power (e.g., per resource block (RB) and/or the like) at a recipient of the signal. The UE 120 may not be permitted to transmit a signal at a transmit power that causes the signal to exceed the allowable reception power level at a recipient. In this case, the UE 120 may determine a pathloss value for a downlink transmission from the BS 110, and may determine the transmit power for the signal using the pathloss value and the allowable reception power level. In some aspects, the allowable reception power level may be equal to or based at least in part on an expected reception power level, per RB, of a PUSCH, a physical uplink control channel, an SRS, and/or the like. In some aspects, the configuration information may indicate a combination of a transmit power parameter (e.g., a maximum transmit power) and an allowable reception power level. For example, the UE 120 may be permitted to transmit a signal that is below the maximum transmit power and that is expected to be received at a power level that satisfies the allowable reception power level. Thus, interference at other nodes or UEs is reduced relative to transmitting the signal at full power or an unreduced power.

In some aspects, the configuration information may indicate a beamforming direction parameter for the signal. For example, the BS 110 may configure the beamforming direction parameter to reduce interference at UEs or nodes in a spatial direction. In some aspects, the BS 110 may indicate a set of allowable beamforming directions. Additionally, or alternatively, the BS 110 may indicate a set of disallowed beamforming directions to the UE 120. The UE 120 may be permitted to transmit the signal in the configured set of resources in accordance with the beamforming direction parameter.

In some aspects, a beamforming direction can be represented by a codeword in a spatial precoding codebook, such as a transmission precoding matrix indicator (TPMI) value from a TPMI codebook. In some aspects, a beamforming direction can be associated with a reference signal. For example, a beamforming direction may be represented by a downlink reference signal resource (such as a synchronization signal block (SSB) resource or a CSI-RS resource), meaning that the beamforming direction is a direction that can be used to achieve a highest signal to interference plus noise ratio (SINR) in reception at a given reference signal resource, based at least in part on DL-UL reciprocity. As another example, a beamforming direction may be represented by an uplink reference signal resource (such as an SRS resource), meaning that the beamforming direction matches a direction that is used to transmit signals in this UL reference signal resource.

In some aspects, the BS 110 may indicate a transmit power parameter for a beamforming direction. For example, the BS 110 may indicate a beamforming direction parameter and a corresponding transmit power parameter to be used for the beamforming direction. The transmit power parameter may include any of the transmit power parameters described above, and the beamforming direction parameter may include any of the beamforming direction parameters described above. Thus, the BS 110 may configure the UE 120 to reduce transmit power in a given direction, which may reduce interference at UEs or nodes located in the given direction relative to the UE 120.

As mentioned above, in some aspects, the BS 110 may provide the configuration information to an IAB node in order to configure the IAB node to measure self-interference. In this case, the BS 110 (e.g., a CCN) may configure the IAB node, as well as a parent node of the IAB node, with resources for self-interference measurement. Thus, the parent node may be able to avoid scheduling transmissions on the parent backhaul link during the resources for self-interference measurement without interference or scheduling issues. In other aspects, the BS 110 (e.g., a parent node of the IAB node) may configure the IAB node with the resources for self-interference measurement. For example, for an IAB node performing MT reception and DU transmission, the parent node may configure the resources of a downlink parent backhaul link for self-interference measurement to the IAB node. In this case, the parent node may transmit a CSI-RS at the configured resource. As another example, for an IAB node performing MT transmission and DU reception, the parent node may configure the resources of an uplink parent backhaul link for self-interference measurement to the IAB node. In this case, the parent node may schedule an SRS at the configured resource.

As shown by reference number 720, the UE 120 may transmit the signal in accordance with the configuration information. For example, depending on the content of the configuration information, the UE 120 may transmit the signal using a specified transmission sequence, in a set of resources indicated by the configuration information, in accordance with a transmit power parameter, and/or using a beam (e.g., in a direction) specified by the configuration information. Thus, the UE 120 may reduce interference at other UEs or nodes based at least in part on the configuration information. As shown by reference number 730, the UE 120 may determine a self-interference measurement based at least in part on the signal. For example, the UE 120 may measure interference at the set of resources indicated by the configuration information, and may determine the self-interference measurement based at least in part on the signal. As shown by reference number 740, the UE 120 may transmit information indicating the self-interference measurement to the BS 110. For example, the information indicating the self-interference measurement may indicate a self-interference strength value (e.g., a value indicating a power level of the self-interference), a CSI value calculated based at least in part on a self-interference strength value, and/or the like.

As indicated above, FIG. 7 is provided as an example. Other examples may differ from what is described with respect to FIG. 7.

FIG. 8 is a diagram illustrating an example process 800 performed, for example, by a node, in accordance with various aspects of the present disclosure. Example process 800 is an example where the node (e.g., UE 120, IAB node 410, and/or the like) performs operations associated with radio resource configuration for self-interference measurement.

As shown in FIG. 8, in some aspects, process 800 may include receiving configuration information that indicates a set of resources for self-interference measurement associated with a full-duplex communication mode (block 810). For example, the node (e.g., using antenna 252, DEMOD 254, MIMO detector 256, receive processor 258, controller/processor 280, and/or the like) may receive configuration information that indicates a set of resources for self-interference measurement associated with a full-duplex communication mode, as described above. In some aspects, the configuration information may include any of the indications described above in connection with reference number 710 of FIG. 7.

As shown in FIG. 8, in some aspects, process 800 may optionally include determining a transmit power for the signal based at least in part on the allowable reception power level and based at least in part on a pathloss value (block 820). For example, the node (e.g., using antenna 252, DEMOD 254, MIMO detector 256, receive processor 258, controller/processor 280, and/or the like) may determine a transmit power for the signal based at least in part on the allowable reception power level and based at least in part on a pathloss value, as described above. In this case, the configuration information may identify the allowable reception power level, and the node may determine the pathloss value.

As further shown in FIG. 8, in some aspects, process 800 may include transmitting a signal in accordance with the configuration information (block 830). For example, the node (e.g., using controller/processor 280, transmit processor 264, TX MIMO processor 266, MOD 254, antenna 252, and/or the like) may transmit a signal in accordance with the configuration information, as described above. In some aspects, depending on the content of the configuration information, the node may transmit the signal using a specified transmission sequence, in a set of resources indicated by the configuration information, in accordance with a transmit power parameter, and/or using a beam (e.g., in a direction) specified by the configuration information.

As further shown in FIG. 8, in some aspects, process 800 may include determining a self-interference measurement based at least in part on the signal and the set of resources (block 840). For example, the node (e.g., using antenna 252, DEMOD 254, MIMO detector 256, receive processor 258, controller/processor 280, and/or the like) may determine a self-interference measurement based at least in part on the signal and the set of resources, as described above. In some aspects, the node may determine the self-interference measurement in accordance with the configuration, as described, for example, in connection with reference number 730 of FIG. 7.

As further shown in FIG. 8, in some aspects, process 800 may include transmitting information indicating the self-interference measurement (block 850). For example, the node (e.g., using controller/processor 280, transmit processor 264, TX MIMO processor 266, MOD 254, antenna 252, and/or the like) may transmit information indicating the self-interference measurement, as described above.

Process 800 may include additional aspects, such as any single aspect or any combination of aspects described below and/or in connection with one or more other processes described elsewhere herein.

In a first aspect, based at least in part on the self-interference measurement being associated with a non-zero-power channel state information reference signal (NZP-CSI-RS) reception, the set of resources includes one or more resource elements of an NZP-CSI-RS resource. An NZP-CSI-RS is a downlink reference signal transmitted at non-zero power on an NZP-CSI-RS resource. An NZP-CSI-RS can be used for Layer 1 RSRP determination, downlink CSI acquisition, interference measurement, time and frequency tracking, and/or the like. An NZP-CSI-RS can be compared to a zero-power (ZP)_CSI-RS, which is associated with a resource in which no CSI-RS is transmitted. A ZP-CSI-RS can be used for downlink CSI acquisition, interference measurement, and masking of one or more resource elements to make the resource elements unavailable for shared channel transmission.

In a second aspect, alone or in combination with the first aspect, the configuration information explicitly indicates a location of the set of resources.

In a third aspect, alone or in combination with one or more of the first and second aspects, the configuration information indicates that the set of resources includes the one or more resource elements of the NZP-CSI-RS resource.

In a fourth aspect, alone or in combination with one or more of the first through third aspects, the configuration information indicates a transmit power parameter for the signal, and transmission of the signal is based at least in part on the transmit power parameter.

In a fifth aspect, alone or in combination with one or more of the first through fourth aspects, the transmit power parameter indicates a maximum transmit power for the signal.

In a sixth aspect, alone or in combination with one or more of the first through fifth aspects, the transmit power parameter indicates an allowable reception power level, and process 800 further comprises determining a transmit power for the signal based at least in part on the allowable reception power level and based at least in part on a pathloss value.

In a seventh aspect, alone or in combination with one or more of the first through sixth aspects, the transmit power parameter indicates a maximum transmit power for the signal and an allowable reception power level.

In an eighth aspect, alone or in combination with one or more of the first through seventh aspects, the configuration information indicates a beamforming direction parameter for the signal, and transmission of the signal is based at least in part on the beamforming direction parameter.

In a ninth aspect, alone or in combination with one or more of the first through eighth aspects, the beamforming direction parameter indicates a set of allowable beamforming directions.

In a tenth aspect, alone or in combination with one or more of the first through ninth aspects, the beamforming direction parameter indicates a set of disallowed beamforming directions.

In an eleventh aspect, alone or in combination with one or more of the first through tenth aspects, the beamforming direction parameter is based at least in part on a codeword of a spatial precoding codebook.

In a twelfth aspect, alone or in combination with one or more of the first through eleventh aspects, the beamforming direction parameter is indicated relative to an uplink reference signal or a downlink reference signal.

In a thirteenth aspect, alone or in combination with one or more of the first through twelfth aspects, the configuration information indicates a set of allowable beamforming directions and a set of respective transmission power parameters associated with the set of allowable beamforming directions.

In a fourteenth aspect, alone or in combination with one or more of the first through thirteenth aspects, the configuration information is received via at least one of: downlink control information, medium access control information, radio resource control information, or a combination thereof.

In a fifteenth aspect, alone or in combination with one or more of the first through fourteenth aspects, the configuration information is received in a channel state information report configuration message.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with various aspects of the present disclosure. Example process 900 is an example where the base station (e.g., base station 110, an IAB donor, an IAB parent node, and/or the like) performs operations associated with radio resource configuration for self-interference measurement.

As shown in FIG. 9, in some aspects, process 900 may include transmitting configuration information that indicates a set of resources for self-interference measurement by a node associated with a full-duplex communication mode (block 910). For example, the base station (e.g., using controller/processor 240, transmit processor 220, TX MIMO processor 230, MOD 232, antenna 234, and/or the like) may transmit configuration information that indicates a set of resources for self-interference measurement by a node associated with a full-duplex communication mode, as described above. In some aspects, the configuration information may include one or more of information indicating a set of resources for self-interference measurement associated with a full-duplex communication mode, information indicating a transmit power parameter for a signal, information indicating a beamforming direction parameter for the signal, or information indicating a transmission sequence for the signal

As further shown in FIG. 9, in some aspects, process 900 may include receiving, from the node and in accordance with the configuration information, information indicating the self-interference measurement (block 920). For example, the base station (e.g., using antenna 234, DEMOD 232, MIMO detector 236, receive processor 238, controller/processor 240, and/or the like) may receive, from the node and in accordance with the configuration information, information indicating the self-interference measurement, as described above. This information may include, for example, a CSI measurement report, information indicating an interference signal strength, and/or the like.

Process 900 may include additional aspects, such as any single aspect or any combination of aspects described below and/or in connection with one or more other processes described elsewhere herein.

In a first aspect, based at least in part on the self-interference measurement being associated with NZP-CSI-RS reception, the set of resources includes one or more resource elements of an NZP-CSI-RS resource.

In a second aspect, alone or in combination with the first aspect, the configuration information explicitly indicates a location of the set of resources.

In a third aspect, alone or in combination with one or more of the first and second aspects, the configuration information indicates that the set of resources includes the one or more resource elements of the NZP-CSI-RS resource.

In a fourth aspect, alone or in combination with one or more of the first through third aspects, the configuration information indicates a transmit power parameter for the signal, and reception of the signal is based at least in part on the transmit power parameter.

In a fifth aspect, alone or in combination with one or more of the first through fourth aspects, the transmit power parameter indicates a maximum transmit power for the signal.

In a sixth aspect, alone or in combination with one or more of the first through fifth aspects, the transmit power parameter indicates an allowable reception power level at which the signal is to be received.

In a seventh aspect, alone or in combination with one or more of the first through sixth aspects, the transmit power parameter indicates a maximum transmit power for the signal and an allowable reception power level at which the signal is to be received.

In an eighth aspect, alone or in combination with one or more of the first through seventh aspects, the configuration information indicates a beamforming direction parameter for the signal, and reception of the signal is based at least in part on the beamforming direction parameter.

In a ninth aspect, alone or in combination with one or more of the first through eighth aspects, the beamforming direction parameter indicates a set of allowable beamforming directions.

In a tenth aspect, alone or in combination with one or more of the first through ninth aspects, the beamforming direction parameter indicates a set of disallowed beamforming directions.

In an eleventh aspect, alone or in combination with one or more of the first through tenth aspects, the beamforming direction parameter is based at least in part on a codeword of a spatial precoding codebook.

In a twelfth aspect, alone or in combination with one or more of the first through eleventh aspects, the beamforming direction parameter is indicated relative to an uplink reference signal or a downlink reference signal.

In a thirteenth aspect, alone or in combination with one or more of the first through twelfth aspects, the configuration information indicates a set of allowable beamforming directions and a set of respective transmission power parameters associated with the set of allowable beamforming directions.

In a fourteenth aspect, alone or in combination with one or more of the first through thirteenth aspects, the configuration information is transmitted via at least one of: downlink control information, medium access control information, radio resource control information, or a combination thereof.

In a fifteenth aspect, alone or in combination with one or more of the first through fourteenth aspects, the configuration information is received in a channel state information report configuration message.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

The following provides an overview of some Aspects of the present disclosure:

Aspect 1: A method of wireless communication performed by a node, comprising: receiving configuration information that indicates a set of resources for self-interference measurement associated with a full-duplex communication mode; transmitting a signal in accordance with the configuration information; determining a self-interference measurement based at least in part on the signal and the set of resources; and transmitting information indicating the self-interference measurement.

Aspect 2: The method of Aspect 1, wherein, based at least in part on the self-interference measurement being associated with a non-zero-power channel state information reference signal (NZP-CSI-RS) reception, the set of resources includes one or more resource elements of an NZP-CSI-RS resource.

Aspect 3: The method of Aspect 2, wherein the configuration information explicitly indicates a location of the set of resources.

Aspect 4: The method of Aspect 2, wherein the configuration information indicates that the set of resources includes the one or more resource elements of the NZP-CSI-RS resource.

Aspect 5: The method of any of Aspects 1-4, wherein the configuration information indicates a transmit power parameter for the signal, and wherein transmission of the signal is based at least in part on the transmit power parameter.

Aspect 6: The method of Aspect 5, wherein the transmit power parameter indicates a maximum transmit power for the signal, and wherein a transmit power for the signal is determined to be lower than the maximum transmit power.

Aspect 7: The method of Aspect 5, wherein the transmit power parameter indicates an allowable reception power level, and wherein the method further comprises: determining a transmit power for the signal based at least in part on the allowable reception power level and based at least in part on a pathloss value.

Aspect 8: The method of Aspect 5, wherein the transmit power parameter indicates a maximum transmit power for the signal and an allowable reception power level.

Aspect 9: The method of any of Aspects 1-8, wherein the configuration information indicates a beamforming direction parameter for the signal, and wherein transmission of the signal is based at least in part on the beamforming direction parameter.

Aspect 10: The method of Aspect 9, wherein the beamforming direction parameter is based at least in part on a codeword of a spatial precoding codebook.

Aspect 11: The method of Aspect 9, wherein the beamforming direction parameter is indicated relative to an uplink reference signal or a downlink reference signal.

Aspect 12: The method of Aspect 9, wherein the configuration information indicates a set of allowable beamforming directions and a set of respective transmission power parameters associated with the set of allowable beamforming directions.

Aspect 13: The method of any of Aspects 1-12, wherein the configuration information is received via at least one of: downlink control information, medium access control information, radio resource control information, or a combination thereof.

Aspect 14: The method of any of Aspects 1-13, wherein the configuration information is received in a channel state information report configuration message.

Aspect 15: The method of any of Aspects 1-14, wherein the information indicating the self-interference measurement indicates at least one of a self-interference strength value or a channel state information value that is based at least in part on the self-interference strength value.

Aspect 16: The method of any of Aspects 1-15, wherein the configuration information indicates a transmission sequence for the signal.

Aspect 17: The method of any of Aspects 1-16, wherein the configuration information is received from a central unit associated with the node.

Aspect 18: The method of any of Aspects 1-17, wherein the configuration information is received from a parent node of the node.

Aspect 19: A method of wireless communication performed by a base station, comprising transmitting configuration information that indicates a set of resources for self-interference measurement by a node associated with a full-duplex communication mode; and receiving, from the node and in accordance with the configuration information, information indicating the self-interference measurement.

Aspect 20: The method of Aspect 19, wherein, based at least in part on the self-interference measurement being associated with a non-zero-power channel state information reference signal (NZP-CSI-RS) reception, the set of resources includes one or more resource elements of an NZP-CSI-RS resource.

Aspect 21: The method of any of Aspects 19-20, wherein the configuration information indicates a transmit power parameter for a signal associated with the self-interference measurement.

Aspect 22: The method of any of Aspects 19-21, wherein the configuration information indicates a beamforming direction parameter for a signal associated with the self-interference measurement, and wherein reception of the signal is based at least in part on the beamforming direction parameter.

Aspect 23: The method of Aspect 22, wherein the configuration information indicates a set of allowable beamforming directions and a set of respective transmission power parameters associated with the set of allowable beamforming directions.

Aspect 24: The method of any of Aspects 19-23, wherein the configuration information is received in a channel state information report configuration message.

Aspect 25: The method of any of Aspects 19-24, wherein the information indicating the self-interference measurement indicates at least one of a self-interference strength value or a channel state information value that is based at least in part on the self-interference strength value.

Aspect 26: The method of any of Aspects 19-25, wherein the configuration information indicates a transmission sequence for a signal associated with determining the self-interference measurement.

Aspect 27: An apparatus for wireless communication at a device, comprising a processor; memory coupled with the processor; and instructions stored in the memory and executable by the processor to cause the apparatus to perform the method of one or more Aspects of Aspects 1-26.

Aspect 28: A device for wireless communication, comprising a memory and one or more processors coupled to the memory, the memory and the one or more processors configured to perform the method of one or more Aspects of Aspects 1-26.

Aspect 29: An apparatus for wireless communication, comprising at least one means for performing the method of one or more Aspects of Aspects 1-26.

Aspect 30: A non-transitory computer-readable medium storing code for wireless communication, the code comprising instructions executable by a processor to perform the method of one or more Aspects of Aspects 1-26.

Aspect 31: A non-transitory computer-readable medium storing a set of instructions for wireless communication, the set of instructions comprising one or more instructions that, when executed by one or more processors of a device, cause the device to perform the method of one or more Aspects of Aspects 1-26.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a node, comprising:
receiving configuration information that indicates a set of resources for self-interference measurement associated with a full-duplex communication mode;
transmitting a signal in accordance with the configuration information;
determining a self-interference measurement based at least in part on the signal and the set of resources; and
transmitting information indicating the self-interference measurement.

2. The method of claim 1, wherein, based at least in part on the self-interference measurement being associated with a non-zero-power channel state information reference signal (NZP-CSI-RS) reception, the set of resources includes one or more resource elements of an NZP-CSI-RS resource.

3. The method of claim 2, wherein the configuration information explicitly indicates a location of the set of resources.

4. The method of claim 2, wherein the configuration information indicates that the set of resources includes the one or more resource elements of the NZP-CSI-RS resource.

5. The method of claim 1, wherein the configuration information indicates a transmit power parameter for the signal, and wherein transmission of the signal is based at least in part on the transmit power parameter.

6. The method of claim 5, wherein the transmit power parameter indicates a maximum transmit power for the signal, and wherein a transmit power for the signal is determined to be lower than the maximum transmit power.

7. The method of claim 5, wherein the transmit power parameter indicates an allowable reception power level, and wherein the method further comprises:
determining a transmit power for the signal based at least in part on the allowable reception power level and based at least in part on a pathloss value.

8. The method of claim 5, wherein the transmit power parameter indicates a maximum transmit power for the signal and an allowable reception power level.

9. The method of claim 1, wherein the configuration information indicates a beamforming direction parameter for the signal, and wherein transmission of the signal is based at least in part on the beamforming direction parameter.

10. The method of claim 9, wherein the beamforming direction parameter is based at least in part on a codeword of a spatial precoding codebook.

11. The method of claim 9, wherein the beamforming direction parameter is indicated relative to an uplink reference signal or a downlink reference signal.

12. The method of claim 9, wherein the configuration information indicates a set of allowable beamforming directions and a set of respective transmission power parameters associated with the set of allowable beamforming directions.

13. The method of claim 1, wherein the configuration information is received via at least one of:
downlink control information,
medium access control information,
radio resource control information, or
a combination thereof.

14. The method of claim 1, wherein the configuration information is received in a channel state information report configuration message.

15. The method of claim 1, wherein the information indicating the self-interference measurement indicates at least one of a self-interference strength value or a channel state information value that is based at least in part on the self-interference strength value.

16. The method of claim 1, wherein the configuration information indicates a transmission sequence for the signal.

17. The method of claim 1, wherein the configuration information is received from a central unit associated with the node.

18. The method of claim 1, wherein the configuration information is received from a parent node of the node.

19. A method of wireless communication performed by a base station, comprising
transmitting configuration information that indicates a set of resources for self-interference measurement by a node associated with a full-duplex communication mode; and
receiving, from the node and in accordance with the configuration information, information indicating the self-interference measurement.

20. The method of claim 19, wherein, based at least in part on the self-interference measurement being associated with a non-zero-power channel state information reference signal (NZP-CSI-RS) reception, the set of resources includes one or more resource elements of an NZP-CSI-RS resource.

21. The method of claim 19, wherein the configuration information indicates a transmit power parameter for a signal associated with the self-interference measurement.

22. The method of claim 19, wherein the configuration information indicates a beamforming direction parameter for a signal associated with the self-interference measurement, and wherein reception of the signal is based at least in part on the beamforming direction parameter.

23. The method of claim 22, wherein the configuration information indicates a set of allowable beamforming directions and a set of respective transmission power parameters associated with the set of allowable beamforming directions.

24. The method of claim 19, wherein the configuration information is received in a channel state information report configuration message.

25. The method of claim 19, wherein the information indicating the self-interference measurement indicates at least one of a self-interference strength value or a channel state information value that is based at least in part on the self-interference strength value.

26. The method of claim 19, wherein the configuration information indicates a transmission sequence for a signal associated with determining the self-interference measurement.

27. A node for wireless communication, comprising:
a memory; and
one or more processors operatively coupled to the memory, the one or more processors configured to:
receive configuration information that indicates a set of resources for self-interference measurement associated with a full-duplex communication mode;
transmit a signal in accordance with the configuration information;
determine a self-interference measurement based at least in part on the signal and the set of resources; and
transmit information indicating the self-interference measurement.

28. The node of claim 27, wherein, based at least in part on the self-interference measurement being associated with a non-zero-power channel state information reference signal (NZP-CSI-RS) reception, the set of resources includes one or more resource elements of an NZP-CSI-RS resource.

29. A base station for wireless communication, comprising:
a memory; and
one or more processors operatively coupled to the memory, the memory and the one or more processors configured to:
transmit configuration information that indicates a set of resources for self-interference measurement by a node associated with a full-duplex communication mode; and
receive, from the node and in accordance with the configuration information, information indicating the self-interference measurement.

30. The base station of claim 29, wherein, based at least in part on the self-interference measurement being associated with a non-zero-power channel state information reference signal (NZP-CSI-RS) reception, the set of resources includes one or more resource elements of an NZP-CSI-RS resource.
